(19) United States
(12) Patent Application Publication
(10) Pub. No.: US 2015/0288207 A1
(43) Pub. Date: Oct. 8, 2015

(54) System and Method for Smart Charging a Mobile Device

(71) Applicants: Jeffrey Alan Walker, JR., Chicago, IL (US); Michael Robert Kelly, Chicago, IL (US)

(72) Inventors: Jeffrey Alan Walker, JR., Chicago, IL (US); Michael Robert Kelly, Chicago, IL (US)

(21) Appl. No.: 14/676,644

(22) Filed: Apr. 1, 2015

Related U.S. Application Data
(60) Provisional application No. 61/974,915, filed on Apr. 3, 2014.

(51) Int. Cl. H02J 7/00

(52) U.S. Cl. CPC H02J 7/0044

(57) ABSTRACT

A smart mobile device charger comprises a communication unit configured to communicate with at least one first device. The communication unit is further configured to receive a first charge authorization signal from a mobile application associated with each of the at least one first device. A charging unit is coupled to the communication unit the and the charging unit is configured to charge at least one first mobile device based at least in part on the first charge authorization signal. Also disclosed are a method and system of smart charging mobile devices.

### RELATED APPLICATIONS

This application claims priority from U.S. Provisional Patent Application Ser. No. 61/974,915, filed Apr. 3, 2014, entitled “System and Method for Smart Charging a Mobile Device,” which is hereby incorporated by reference.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

Portable and standard (plugged into a wall outlet) mobile device and smartphone chargers are widely available for retail sale. Conventional mobile device chargers recharge, or provide power to, mobile devices based on power requirements of the mobile devices. Power is provided to the mobile device given that the charging interface between the charger (male connector) and the mobile device (female connector) match. Thus, when a mobile device charger connects to a mobile device, the mobile device charger will automatically provide power to the mobile device.

Generally, people do not carry portable mobile device chargers with them when going out in public, such as to the workplace or dining at a restaurant. When mobile devices run low on charge while in public, mobile device chargers are often unavailable. If by chance the establishment has mobile device chargers on hand, it is difficult for the establishment to maintain control of the mobile device chargers.

Thus, there is a need to control, track, and monetize the use of conventional mobile device chargers.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a series of mobile application interfaces for initialization on a mobile device for use with a smart mobile device charger in accordance with various embodiments;

FIG. 2 illustrates a series of mobile application interfaces for an unregistered mobile device when connected to a smart mobile device charger in accordance with various embodiments;

FIG. 3 illustrates a mobile application interface for a registered mobile device when connected to a smart mobile device charger in accordance with various embodiments;

FIG. 4 illustrates a mobile app marketplace interface displayed when a mobile device without the mobile application is connected to a smart mobile device charger in accordance with various embodiments;

FIG. 5 illustrates a network block diagram of a mobile device smart charging system in accordance with various embodiments;

FIG. 6 illustrates a process flow diagram illustrating a method of mobile device smart charging in accordance with various embodiments;

FIG. 7 is a generalized hardware block diagram illustrating a mobile device charger in accordance with various embodiments.

### DETAILED DESCRIPTION

While various aspects and features of certain embodiments have been summarized above, the following detailed description illustrates a few embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

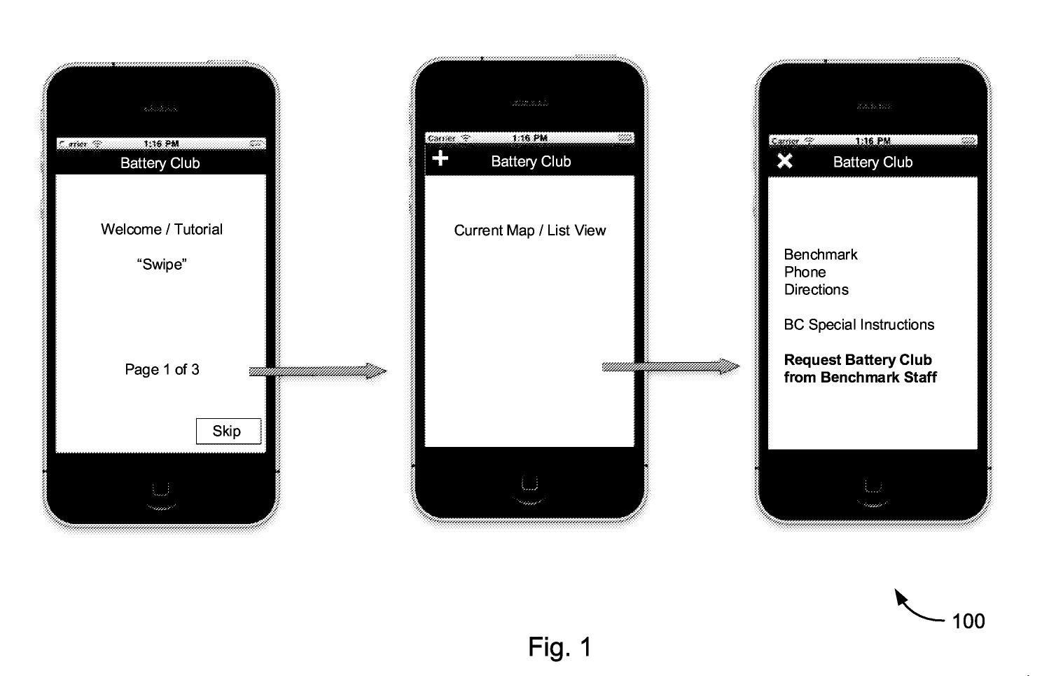

FIG. 1 shows a series of mobile application interfaces 100 when a smart charger mobile app is installed on a mobile device. When the smart charger mobile app is initialized, smart charging locations, i.e. locations where smart mobile device chargers are available, are shown. The user of a mobile device is able to select between viewing the smart charging locations in a map view or in a textual list view. In some embodiments, both of these views may be displayed simultaneously. In various embodiments, the smart charger mobile app pinpoints the physical location of the mobile device via a global positioning system (GPS) signal from the mobile device. The smart charger mobile app then determines a list of the nearest smart charging locations around the mobile device.

When a location is selected, a location information interface is presented. The location information interface includes, but is not limited to, the name of the smart charging location (i.e. “Benchmark”), contact information such as phone number, address, directions to the smart charging location, or any other contact information may be displayed. In one embodiment, the app uses “geofencing” so that it automatically recognizes when you are inside, i.e. within a geofence, a certain smart charging location so that the smart charger mobile app automatically knows the mobile device's physical location prior to renting the charger. The smart charger mobile app is also configured to be able to push notifications to the mobile device that will automatically alert users when their phone battery hits a threshold charge level, and notify them of the nearest smart charging location. The location information interface also allows the user to enter special requests and/or instructions regarding the use and/or acquisition of a smart mobile device charger (i.e. “BC Special Instructions”), and allows the user to reserve or request a smart mobile device charger from the location.

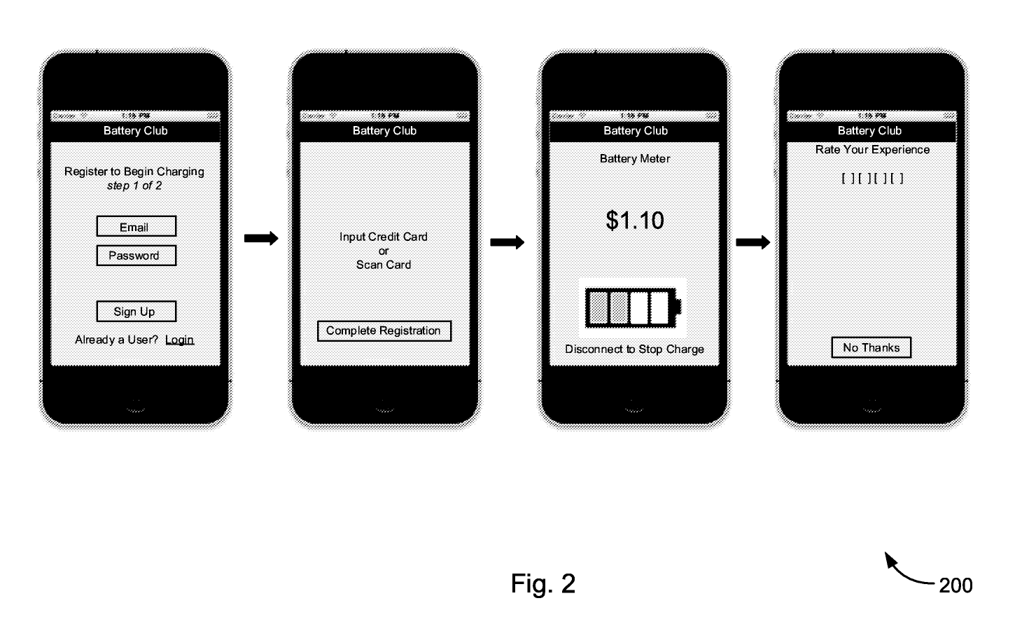

FIG. 2 shows a series of mobile application interfaces 200 when an unregistered mobile device having the smart charger mobile app installed is connected to a smart mobile device charger. When the mobile device is connected to the smart mobile device charger, a registration screen is displayed by the smart charger mobile app on the mobile device. A user is then able to register their mobile device by providing an email address and password. It is to be understood that other forms of user identification may be used to register the mobile device or to create a registered account, and is not limited to the use of an email address and a password. For example, in some embodiments, unique user identification may be assigned by the mobile application. In other embodiments, the user may simply create a username for the account and tie it to a form of personal information, or use personal information directly. Personal information includes, but is not limited, personally identifying information such as an email address, name, date of birth, home (street) address, credit card information, etc. If the user already has a registered account, a login prompt may be used by the user to enter account information.

To complete registration of an account, credit card information, or other form of payment information, is entered. Payment information can include, but is not limited to, credit card information, checking account information, and electronic forms of payment such as PayPal and electronic currency such as Bitcoin, etc. Once payment information is entered in, and the user logs in with their account, the user is able to start charging their mobile device. The user may be charged a fee for charging their mobile device in various ways. In some embodiments, the user is able to purchase a predetermined amount of charge time. In other embodiments, the user accrues a running tab based on how long the mobile device has been charging. In yet other embodiments, the user is able to pay a predetermined amount of money, or pay to recharge up to a certain percentage of their battery based on the fee. It is to be understood that the methods of charging a fee are provided for illustrative purposes and not intended to be limiting, and therefore other methods of charging a fee for the use of the smart mobile device charger may be implemented. For example, methods for charging a fee include, but are not limited to, a subscription model (unlimited uses per month for a fixed monthly fee), a flat rate fee on a per use basis, or a metered rate fee on a per use basis. Payment information can be stored by the smart charger mobile app so that each time a user rents a smart mobile device charger the payment is automatically and seamlessly made.

In some embodiments, non-remunerative payment options may be made available to a user to secure a charge. For example, a sponsor (e.g., brand owners or organizations seeking to promote their products or services) or the venue hosting the smart charger may enable a charge in exchange for the user's participation of some form of promotion. For example, a like on Facebook, a follow on Twitter, posting to Facebook or Twitter, the viewing of an ad, the watching of an ad video, the downloading of a specified app or the like. If a user elects to participate in the promotion, the user's account will not be assessed for the charge. Embodiments could include a smart charger being enabled for unregistered mobile devices having the smart charger mobile app installed or mobile devices that do not have the smart charger mobile App installed but whose user participates in a promotion.

Once the transaction/mobile device charging has completed, a feedback screen is presented to the user. The rating system within the smart charger mobile app allows users to rate their experience. User can also link their social media to the mobile app so they can post/share/tweet autogenerated content and/or personal promo codes to get credits and discounts towards future rentals.

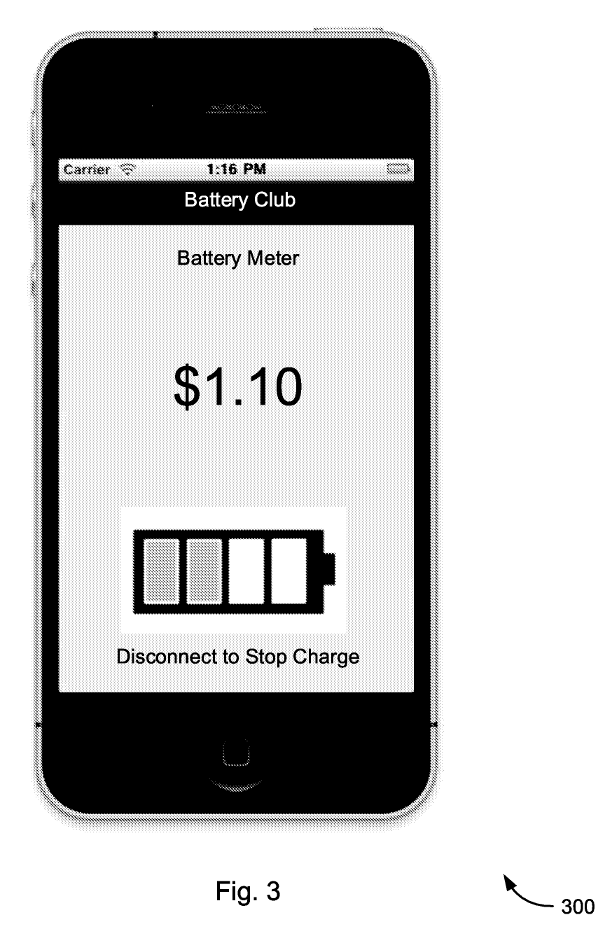

FIG. 3 is a mobile application interface 300 shown to a registered mobile device when connected to a smart mobile device charger. Thus, when a registered mobile device is connected, the user is automatically taken to the charging screen where the user is able to purchase or directly begin charging their mobile device.

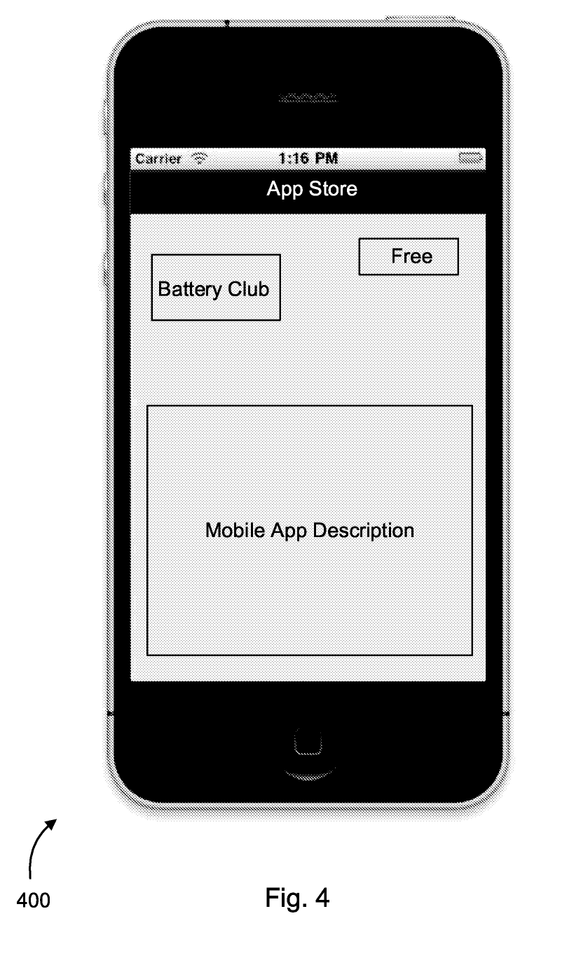

FIG. 4 illustrates a scenario where a mobile device is connected to a smart mobile device charger without first having the smart charger mobile app installed. When connected, a mobile app marketplace interface 400 displayed on the mobile device. The mobile app marketplace interface can be any established mobile app interface that can vary based on the mobile device, such as by manufacturer, operating system, service provider, etc. Mobile app marketplaces can include, but are not limited to, the Apple App Store, Google Play, Windows Phone Apps, and BlackBerryWorld.

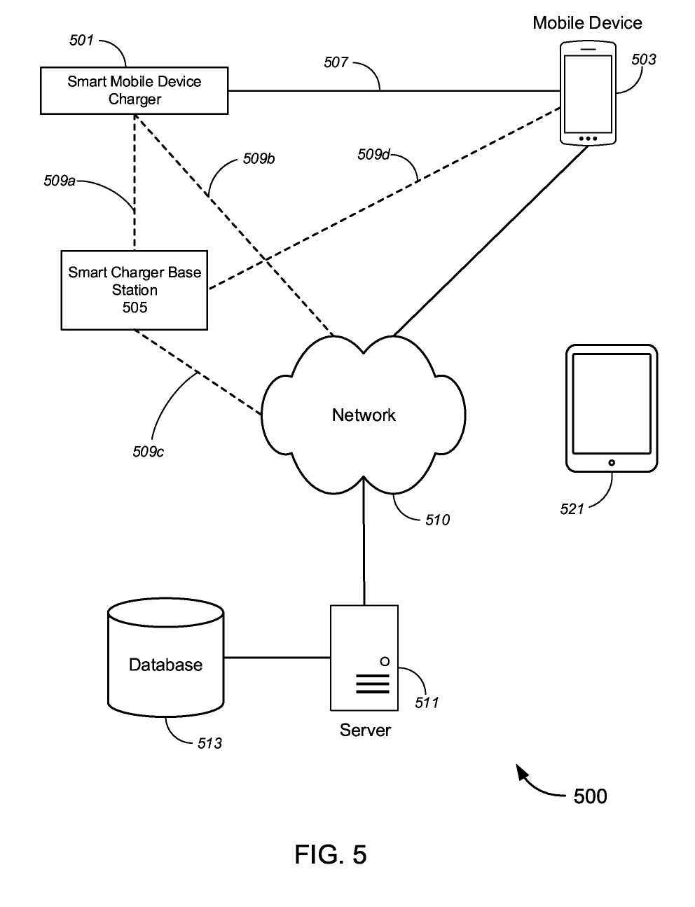

FIG. 5 is a network block diagram of a mobile device smart charging system 500 according to various embodiments. The network block diagram shows the components and various connections between the components of the mobile device smart charging system 500. Mobile device smart charging system 500 includes smart mobile device charger 501, mobile device 503, smart charger base station 505, network 510, mobile application server 511, database 513, and remote device 521. Mobile device 503 is connected to smart mobile device charger 501 via link 507. Link 507 is a physical or wireless link capable of facilitating communication between mobile device 503 and smart mobile device charger 501. Link 507 is also configured to transfer power from smart mobile device charger 501 to mobile device 503. In some embodiments, link 507 is a wired link, which can include, but is not limited to, Apple 30-pin, Apple Lightning, Universal Serial Bus (USB), Micro-USB, Mini-USB, and Thunderbolt connections. In other embodiments, link 507 is a wireless link, which can include, but is not limited to WiFi, Bluetooth, NFC, RF, and IR connections. In some embodiments, a physical cable comprising link 507 is integrated into the body of smart mobile device charger 501. In other embodiments, a separate physical cable may be provided for use with smart mobile device charger 501. Alternatively, a separate wireless link 507 may be used to deliver power, such as by using electromagnetic induction or electromagnetic radiation. Mobile device 503 is also in communication with mobile application server 511 via network 510. Smart mobile device charger 501 is also optionally coupled to a smart charger base station 505 via optional link 509a, and mobile application server 511 via network 510 through optional link 509b. Smart charger base station 505 is also optionally in communication with mobile application server 511 via network 510 through optional link 509c. Mobile application server 511 is coupled to database 513. Network 510 can include, without limitation, a local area network (LAN), a wide area network (WAN), a virtual network, the internet, an intranet, or a personal area network.

Mobile device 503 includes, but is not limited to, smart phones, tablets, laptops, portable media players, personal digital assistants, and any portable electronics devices. Smart mobile device charger 501 can be a portable charger having a separate battery as a power supply, or a plug-in charger needing to be supplied power via a wall outlet. Mobile device 503 and smart mobile device charger 501 communicate via link 507. Smart mobile device charger 501 determines whether mobile device 503 has a smart charger mobile app installed, and also to confirm whether or not it is a registered mobile device. Once the smart charger mobile app is installed on the mobile device 503, the mobile device 503 communicates to the smart mobile device charger 501 via smart charger mobile app. The smart mobile device charger 501 determines whether it should provide power to the connected mobile device 503. In some embodiments, the smart mobile device charger 501 requests or waits for an authorization signal from the mobile device 503 via the mobile application before beginning to charge the mobile device 503. In other embodiments, the smart mobile device charger 501 receives an authorization signal generated by the mobile application server 511, and is provided to the smart mobile device charger 501 via network 510 over link 509b. In yet other embodiments, the smart mobile device charger 501 receives an authorization signal via the smart charger base station 505 over link 509a. In some embodiments, the mobile device 503 may be coupled to smart charger base station 505 via optional link 509d. Then the smart charger base station 505 provides an authorization signal to smart mobile device charger 501. In further embodiments, a remote device 521 may be used to generate the authorization signal and transmit it directly to smart mobile device charger 501, or to cause the mobile device 503, smart charger base station 505, and/or mobile application server 511 to generate the authorization signal. Thus, the remote device 521 may have optional links (not shown) to the smart mobile device charger 501, mobile device 503, smart charger base station 505, and/or mobile application server 511 via network 510.

In the event that the battery of the mobile device 503 is completely dead, or has a severely low battery, and cannot access a mobile app marketplace or run the mobile app, upon initial connection to the smart mobile device charger 501, the user will automatically receive a predetermined amount of power. In some embodiments, the predetermined amount of power is based on a set time, for example, 10 minutes of free charging. In other embodiments, the predetermined amount of power is based on a percentage charge of the battery of the mobile device 503. During this time the mobile device 503 will boot and/or move into a smart charger mobile app discovery phase where the smart mobile device charger 501 detects the presence of the smart charger mobile app on mobile device 503. If the mobile device 503 does not have the smart charger mobile app, the mobile device will be prompted to open a mobile app marketplace interface as described with respect to FIG. 4.

If the mobile device 503 has the smart charger mobile app, the app will open automatically open and immediately prompt the user appropriately depending on whether the mobile device 503 is registered with an account, as described above with respect to FIGS. 1-3. From the mobile application interface, the user will be able to press a button or otherwise indicate whether they wish to rent the smart mobile device charger 501 and continue to receive additional power. If the user of the mobile device 503 confirms that they wish to continue charging the mobile device 503, then an authorization signal is generated to indicate to the smart mobile device charger 501 to continue charging.

The app download, registration, and payment transfer of data can be done over the mobile device/smartphone's cellular data connection, such as a 3G, 4G or other cellular data communication standard, or over a WiFi or wired connection to the internet. The smart charger mobile app can be implemented to use various frameworks for communicating with the chargers, which include, but are not limited to, the Apple MFi Framework and/or Android (USB) Framework integration.

Smart mobile device chargers 501 are optionally coupled to a smart charger base station 505. When the smart mobile device charger 501 is a portable charger, the smart mobile device chargers 501 need to be recharged themselves. Thus, charger base station 505 is configured to communicate and also recharge smart mobile device chargers 501 via optional link 509a. Optional link 509a can be any link, physical or wireless, capable of communicating and delivering power to smart mobile device charger 501, similar to link 507. Smart charger base stations 505 can be custom designed recharging station built specifically for smart mobile device charger 501. In some embodiments, smart charger base stations can dock or hold multiple smart mobile device chargers 501 per smart charger base station 505, e.g. ten smart chargers per station, and operate similarly to docking slots, with each dock having re-charging capabilities. Smart charger base station 505 also communicates charger data, the charger data including, but not limited to, which charger is the most charged and ready for use, which charger needs technical attention, etc.

Smart charger base station 505 also communicates to the mobile application server 511 via the network 510 over optional link 509c. The smart charger base station 505 then communicates charger data to the mobile applications server 511, thus providing a user mobile device 503 with charger data via the smart charger mobile app. Thus the user is able to see, among other things, how many chargers are available (ready for use) at each partner venue location.

The mobile device smart charging system 500 enables a measure of control over rented smart mobile device chargers, and a way to generate revenue from such transactions. Rather than providing conventional chargers for free, or relying on a partnered venue/employee to ensure payment by a customer, the mobile device smart charging system 500 simplifies the responsibility of the partner venue/employee to simply delivering and recharging the smart mobile device chargers 501. The mobile device smart charging system 500 also provides a competitive advantage by providing customers with a portable option to charge their phone compared to competitors that require customers be away from their phone (lock it in a locker box) for potentially several hours.

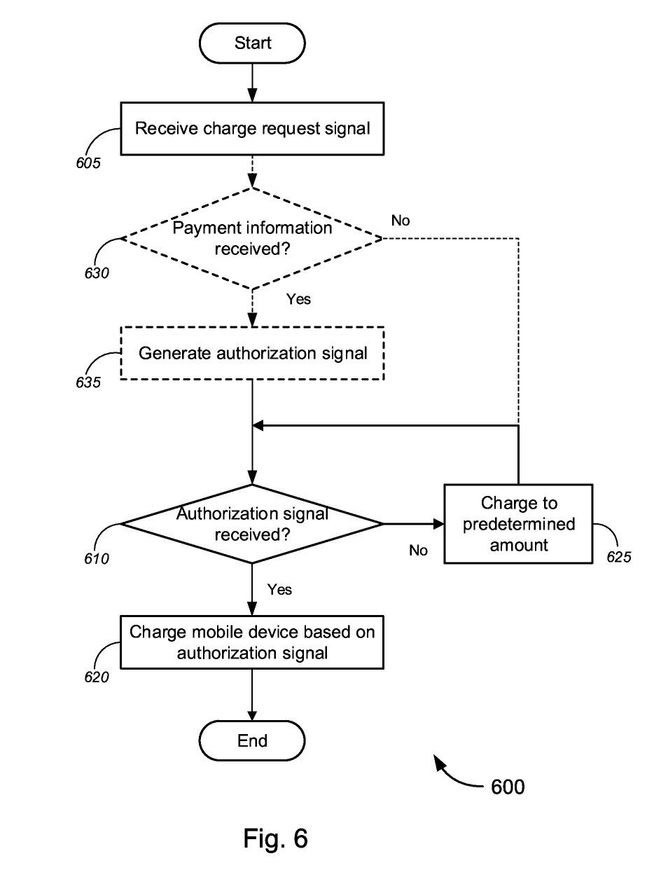

FIG. 6 illustrates a process flow diagram of a method for smart mobile device charging 600 in accordance with various embodiments. At block 605, a charge request signal is received by a smart mobile device charger. When a mobile device connects to a smart mobile device charger, the mobile device sends a request to the smart mobile device charger to begin charging the mobile device. In various embodiments, the smart mobile device charger then enters a mobile app discovery phase. Once the app has been installed and the mobile device registered and/or account created, the smart mobile device charger waits for an authorization signal. At decision block 610, the smart mobile device charger determines whether an authorization signal has been received from the smart charger mobile app. As described above with respect to FIG. 5, in some embodiments, the smart mobile device charger requests or waits for an authorization signal from the mobile device via the mobile application. In other embodiments, the smart mobile device charger receives an authorization signal is generated by a mobile application server, a smart charger base station, or a remote device.

In some embodiments, at optional block 630, the smart mobile device charger determines whether payment information has been received. If payment information was received, at optional block 635, the smart mobile device charger generates an authorization signal. If not, the smart mobile device charger continues to check whether an authorization signal has been received.

If an authorization signal is received, the smart mobile device charges the mobile device based on the authorization signal, at block 620. Thus, in certain embodiments, the authorization signal is indicative of charging parameters, such as whether the mobile device is under a subscription model (unlimited uses per month for a fixed monthly fee), a flat rate fee on a per use basis, or a metered rate fee on a per use basis, as described above with relation to FIG. 5.

If an authorization signal is not received, at block 625, the smart mobile device charger automatically charges the smart phone to a predetermined amount. If the mobile device already holds a charge over the predetermined amount, no charge is provided and the smart mobile device charger awaits an authorization signal.

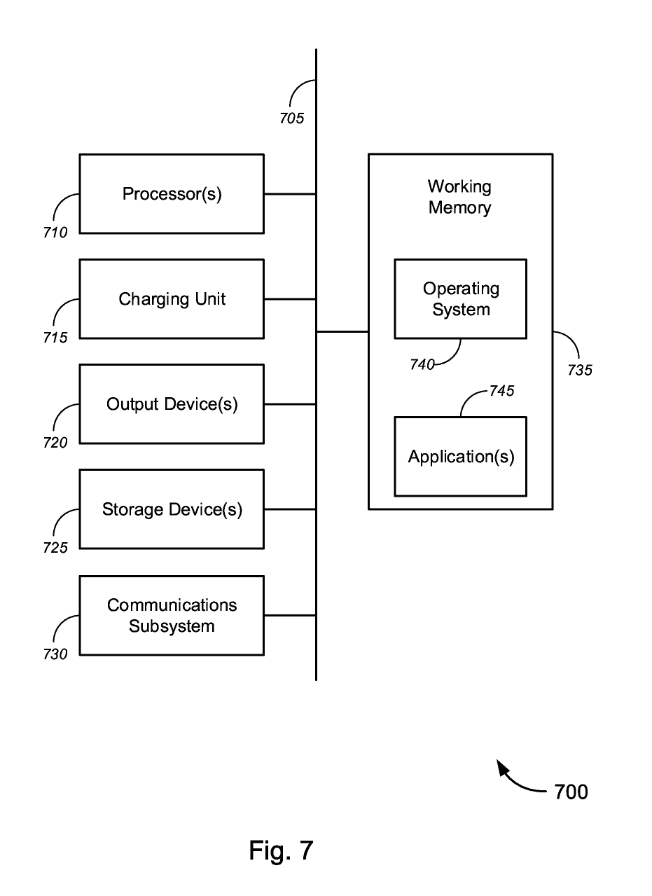

FIG. 7 is a generalized hardware block diagram of the smart mobile device charger 700 in accordance with various embodiments. The smart mobile device charger 700 includes at least one microprocessor 710, a charging unit 715 configured to charge a mobile device and recharge the smart mobile device charger 700, one or more output device 720, including, but not limited to, a light emitting diode indicator, or a display (such as a liquid crystal display or light emitting diode display, touchscreen or otherwise), and one or more storage device 725, including but not limited to, local and/or network accessible storage such as, without limitation, a disk drive or solid-state storage device. Solid state storage data can include, but is not limited to, one or more of a random access memory (RAM) or read only memory (ROM). Charging unit 715 may also include an internal power supply for smart mobile device charger 700 for providing the power for charging a mobile device and the smart mobile device charger, as well as being rechargeable. For example, the internal power supply may be, without limitation, a rechargeable battery.

Smart mobile device charger 700 further includes a communications unit/subsystem 730 configured to communicate with, without limitation, a mobile application on a mobile device, a mobile application server, remote device, and/or a smart charger base station. The communication unit/subsystem 730 is configured to receive an authorization signal from any of the mobile application, mobile device, mobile application server, remote device, and/or a smart charger base station. Communications unit 730 may permit data to be exchanged with a network, mobile device, mobile application server, remote device, and/or smart charger base station via a wireless or wired link, as described above with respect to FIG. 5.

Working memory 735 may include an operating system 740, applications 745, and/or other code. Applications 745 include software elements designed to implement the methods and/or configure systems as provided by embodiments herein. Merely by way of example, applications 745 include instructions that allow the smart mobile device charger to receive a charge request signal from the mobile application, receive the charge authorization signal, and to provide a charging control signal to the charging unit based at least in part on the charge authorization signal.

The instructions and/or code for applications 745 may be encoded or stored on a non-transitory computer readable storage medium, such as the storage device(s) 725 described above. In some cases, the storage medium might be incorporated within a computer system, such as the system 700. In other embodiments, the storage medium might be separate from a computer system—that is, a removable medium, such as a compact disc, a flash memory device, or the like.

It will be apparent to those skilled in the art that substantial variations may be made in accordance with specific requirements. For example, customized hardware—such as programmable logic controllers, field-programmable gate arrays, application-specific integrated circuits, and/or the like—might also be used. In some cases, particular elements might be implemented in hardware, software (including portable software, such as applets, etc.), or both. Further, connection to other computing devices such as network input/output devices may be employed

While the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A smart mobile device charger, comprising:
a communication unit configured to communicate with at least one first device, wherein the communication unit is further configured to receive a first charge authorization signal from a mobile application associated with each of the at least one first device; and
a charging unit coupled to the communication unit, the charging unit configured to charge at least one first mobile device based at least in part on the first charge authorization signal.

2. The smart mobile device charger of claim 1, wherein the at least one first device comprises a third device, wherein the at least one first mobile device comprises a fourth device, and wherein the third device and the fourth device are the same device.

3. The smart mobile device charger of claim 1, further comprising an internal power supply, the internal power supply configured to charge the at least one first mobile device, wherein the internal power supply is configured to be rechargeable via an external power source.

4. The smart mobile device charger of claim 1, wherein the charging unit is further configured to supply only a predetermined amount of power without first receiving the first charge authorization signal.

5. The smart mobile device charger of claim 1, wherein the communication unit is configured to communicate with the at least one first device wirelessly.

6. The smart mobile device charger of claim 1, wherein the communication unit is configured to receive the first charge authorization signal directly from the at least one first device.

7. The smart mobile device charger of claim 1, wherein the communication unit is configured to receive the first charge authorization signal over a communication network through which the mobile application of each of the at least one first device is communicating.

8. The smart mobile device charger of claim 1, wherein the communication unit is further configured to generate a second charge authorization signal, based at least in part on the first charge authorization signal.

9. The smart mobile device charger of claim 1, wherein the at least one first device comprises at least one of a smartphone, tablet, laptop, portable media player, personal digital assistants, other electronic device capable of communicating with the communication unit, a base station, or an application server.

10. The smart mobile device charger of claim 9, wherein the communication unit is configured to communicate payment information from the at least one first device over a communication network.

11. A method of smart charging mobile devices comprising the steps of:
receiving a charge request signal from at least one first device;
receiving a charge authorization signal from a mobile application associated with the at least one first device;
charging at least one first mobile device based at least in part on the charge authorization signal.

12. The method of claim 11, wherein the at least one first device comprises a second device, wherein the at least one first mobile device comprises a third mobile device, and wherein the second device and the third mobile device are the same device.

13. The method of claim 11, further comprising charging the at least one first mobile device by supplying only a predetermined amount of power without first receiving the charge authorization signal.

14. The method of claim 11, wherein receiving the charge authorization signal from a mobile application associated with the at least one first device further comprises receiving the charge authorization signal directly from the at least one first device.

15. The method of claim 11, wherein receiving the charge authorization signal from a mobile application associated with the at least one first device further comprises receiving the charge authorization signal from a communication network over which the mobile application associated with each of the at least one first device is communicating.

16. The method of claim 11, further comprising:
receiving payment information from the at least one first device; and
generating the charge authorization signal based at least in part on the payment information of the at least one first device.

17. A system for the smart charging of mobile devices comprising:
at least one first device, each comprising a mobile charging application;
a network server on a communications network;
a smart mobile device charger, comprising:
a communication unit configured to communicate with the at least one first device, wherein the communication unit is further configured to receive a charge authorization signal from a mobile application associated with each of the at least one first device;
a charging unit coupled to the communication unit, the charging unit configured to charge at least one first mobile device based at least in part on the charge authorization signal;
at least one processor coupled to the communication unit and the charging unit;
a non-transitory computer readable medium in communication with the at least one processor, the computer readable storage medium having stored thereon computer software, the computer software comprising a set of instructions that, when executed by the at least one processor, causes the smart mobile device charger to perform one or more operations, the set of instructions comprising:
instructions to receive a charge request signal from the mobile application associated with the at least one first device;
instructions to receive the charge authorization signal;
instructions to provide a charging control signal to the charging unit to charge at least one first mobile device based at least in part on the charge authorization signal;
wherein the at least one first device is configured to:
communicate with the smart mobile device charger;
communicate with the network server; and
wherein the network server is configured to receive payment information.

18. The system of claim 17, wherein the at least one first device comprises a second device, wherein the at least one first mobile device comprises a third mobile device, and wherein the second mobile device and the third mobile device are the same device.

19. The system of claim 17, wherein the at least one first device is further configured to directly communicate the charge authorization signal to the communication unit.

20. The system of claim 17, wherein the at least one first device is further configured to transmit payment information.

21. The system of claim 17, wherein the smart mobile device charger is further configured to:
receive payment information from the at least one first device;
communicate the payment information from the at least one first device to the network server; and
generate the charge authorization signal based at least in part on the payment information.

22. The system of claim 17, wherein the network server is further configured to generate the charge authorization signal based on the payment information and communicate the charge authorization signal.

23. The system of claim 22, wherein the network server transmits the charge authorization signal to the communication unit.

24. The system of claim 22, wherein the network server transmits the charge authorization signal to the mobile charging application associated with the at least one first device.
